(19) United States
(12) Patent Application Publication
(10) Pub. No.: US 2015/0042086 A1
(43) Pub. Date: Feb. 12, 2015

(54) MOUNTING STRUCTURE OF INTERCOOLER PIPE

(71) Applicants: Kia Motors Corporation, Seoul (KR); Hyundai Motor Company, Seoul (KR)

(72) Inventors: Gi-Hwan Kim, Yongsin-Si (KR); Chi-Hoon CHOI, Suwon-si (KR)

(73) Assignees: Kia Motors Corporation, Seoul (KR); Hyundai Motor Company, Seoul (KR)

(21) Appl. No.: 14/108,170

(22) Filed: Dec. 16, 2013

(30) Foreign Application Priority Data
Aug. 12, 2013 (KR) 10-2013-0095227

(51) Int. Cl. F02C 7/18; F16L 27/11

(52) U.S. Cl. CPC F02C 7/185; F16L 27/11
USPC 285/227

(57) ABSTRACT

A mounting structure of an intercooler pipe including one end connected to an intercooler and another end connected to a connection port of a throttle body. The mounting structure may include a bellow having a plurality of wrinkles consecutively protruding from a surface of the intercooler pipe along a longitudinal direction and a cutting portion formed on the bellow and having a protrusion height different than a protrusion height of the wrinkles Each wrinkle may be formed substantially in a ring shape. The cutting portion may be arranged to form a row of a line shape along the longitudinal direction of the intercooler pipe such that a force required for bending the intercooler pipe toward a specific direction is different than a force required for bending the intercooler pipe toward other directions. The intercooler pipe may be connected to the connection port of the throttle body to be rotated.

### CROSS-REFERENCE TO RELATED APPLICATION

The present application claims priority of Korean Patent Application Number 10-2013-0095227 filed on Aug. 12, 2013, the entire contents of which application are incorporated herein for all purposes by this reference.

### BACKGROUND OF INVENTION

1. Field of Invention

The present disclosure relates to a mounting structure of an intercooler pipe, which is arranged to connect an intercooler and a throttle body of an engine so as to supply the inhalation air (the air inhaled) that is cooled in the intercooler to the engine.

2. Description of Related Art

Generally, an intercooler is a device for cooling the air to be input to an engine of a vehicle. That is, when a turbo device for compressing the air to be inhaled into an engine using an exhaust gas to improve an output of the engine is mounted on a vehicle, the temperature of the compressed air that has passed through the turbo device is increased to inflate its volume and oxygen density thereof is decreased. As a result, an intercooler is mounted additionally to cool the compressed air using cooling water or driving wind so as to increase the oxygen density through cooling the compressed air at high temperature.

That is, the air input from the outside of a vehicle is compressed through the turbo device and is cooled through the intercooler and then input into an engine wherein the intercooler and the throttle body are connected through an intercooler pipe through which air is supplied thereto.

Meanwhile, as shown in FIG. 1, a conventional intercooler pipe is configured such that two bellows 2 made of rubber material are tightened and fixed to both remote ends of a body 1 made of metal material, respectively, through a clamp to be deformed elastically and flexible, and each bellow 2 is configured to be fixed to the intercooler and the throttle body through a clamp using the same way.

However, the conventional intercooler pipe is made of metal material and thus it needs to reduce the weight thereof and both sides thereof are fixed to the intercooler and the throttle body, respectively, and thus it needs to induce a bending toward a specific direction (for example, in order to avoid a collision with a surrounding components) depending on the movement of a vehicle, and further it needs to inhibit the vibration produced from an engine from being transmitted.

In more detail, a research and development for improving NVH (noise, vibration and harshness) performance in the conventional intercooler pipe is only focused on reducing the radiation sound produced due to air flow inside the pipe.

However, when an intercooler pipe is mounted on a vehicle, the vibration transmitted from an engine as well as the radiation sound induces noise having other properties. That is, the intercooler pipe provides a flow channel for transferring the cooled air by connecting an intercooler and a throttle body and at the same time serves as a medium to transmit the vibration produced from an engine to the intercooler.

Accordingly, the vibration produced during the rolling of an engine and from the engine itself is transmitted to the intercooler through an intercooler pipe while the engine is operated, and the vibration vibrates additionally a vehicle body through FEM (front end module) thereby to induce noise into an indoor space of a vehicle.

Meanwhile, the configuration and arrangement of a power transmission device (power train) are arranged differently depending on the kinds of a vehicle in the case of a passenger car wherein a four point mounting way (major connection points of a power train and a vehicle body are formed on four locations) and a three point mounting way (major connection points of a power train and a vehicle body are formed on three locations) are mainly used as the way of supporting an engine and a transmission among the power transmitting devices on a vehicle body. Here, it is confirmed that a rolling of an engine is produced largely relatively in the three point mounting way which is used mainly for a small-middle vehicle and the application fields of which are increased gradually, comparing to the four point mounting way. As a result, the noise and vibration transmitted through the intercooler pipe may be produced more greatly in a vehicle to which the three point mounting is applied and thus the solution to meet the above drawbacks has been required.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve at least some of the above-described problems associated with the prior art.

Various aspects of the present invention provide for a mounting structure of an intercooler pipe which is made of synthetic resin to reduce its weight and in which the slip of the connection portion is allowed in accordance with the movement of an engine so as to inhibit the vibration transmitting and reduce the noise generation and the flexibility of the pipe toward a specific direction (the directions to which the throttle body is vibrated mainly) can be ensured.

Various aspects of the present invention provide for a mounting structure of an intercooler pipe, one end of which is connected to an intercooler and the other end of which is connected to a connection port of a throttle body, according to the present invention, may include the intercooler pipe that includes a bellow on which a plurality of wrinkles are formed consecutively protruding from a surface of the intercooler pipe along a longitudinal direction of the intercooler pipe and a cutting portion formed on the bellow and having a protrusion height that is different than a protrusion height of the wrinkles Each wrinkle in the plurality of wrinkles may be formed substantially in a ring shape. The cutting portion may be arranged to form a row of a line shape along the longitudinal direction of the intercooler pipe such that a force required for bending the intercooler pipe toward a specific direction is different than a force required for bending the intercooler pipe toward other directions. The intercooler pipe may be connected to the connection port of the throttle body to be rotated.

The mounting structure of an intercooler pipe according to the present invention may further include a connector from an inner peripheral surface of which a stopper is protruded and which is connected to a remote end of the intercooler pipe to be fastened to the connection port of the throttle body, wherein when the connection port is entered into the connector, the stopper is caught over a catching step protruded from an outer peripheral surface of the connection port, and the connector allows the intercooler pipe to be rotated.

At least two or more of the rows (for example, first row, second row, third row . . . nth row) may be formed by the cutting portion, arranged adjacently on the bellow along the longitudinal direction of the intercooler pipe, and spaced apart from each other along a surrounding of the bellow.

Two bellows may be formed, one on the one end of the intercooler pipe connected to the intercooler and one on the other end of the intercooler pipe connected to the throttle body, respectively.

The mounting structure of an intercooler pipe according to the present invention may further include a rubber seal arranged on the connector for shielding between the connector and the connection port while the connector is connected to the connection port, wherein at least one of the friction force between the rubber seal and the connector or the friction force between the rubber seal and the connection port is set to be small to allow rotation of the connector.

The intercooler pipe may be made of a material comprising synthetic resin.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing an intercooler pipe according to a related art;

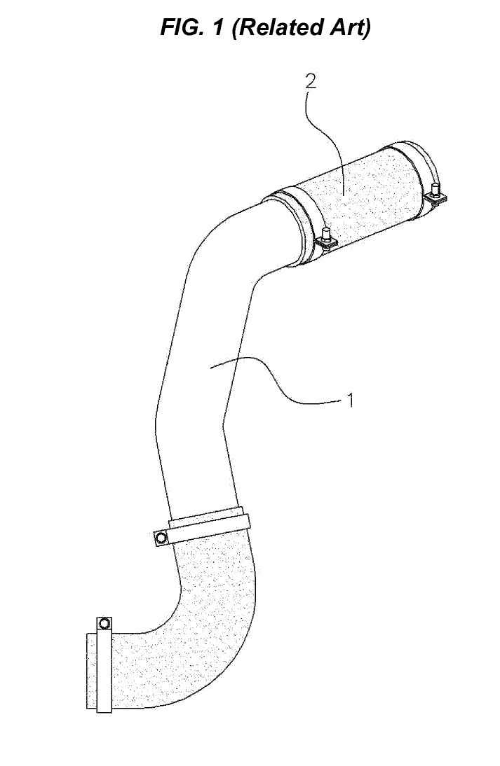

FIG. 2 is a perspective view showing a first exemplary intercooler pipe according to the present invention;

FIG. 3 is a perspective view showing a second exemplary intercooler pipe according to a second embodiment of the present invention;

FIG. 4 is a perspective view showing a throttle body and the throttle body connected to an exemplary intercooler pipe through a connector according to the present invention;

FIG. 5 is a cross-sectional view showing a connection portion of the throttle body and the intercooler pipe as shown in FIG. 4; and

FIG. 6 is a graph showing vibration transmission loss degree per frequency when a conventional intercooler pipe and an exemplary intercooler pipe according to the present invention are arranged to connect a throttle body and an intercooler, respectively.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

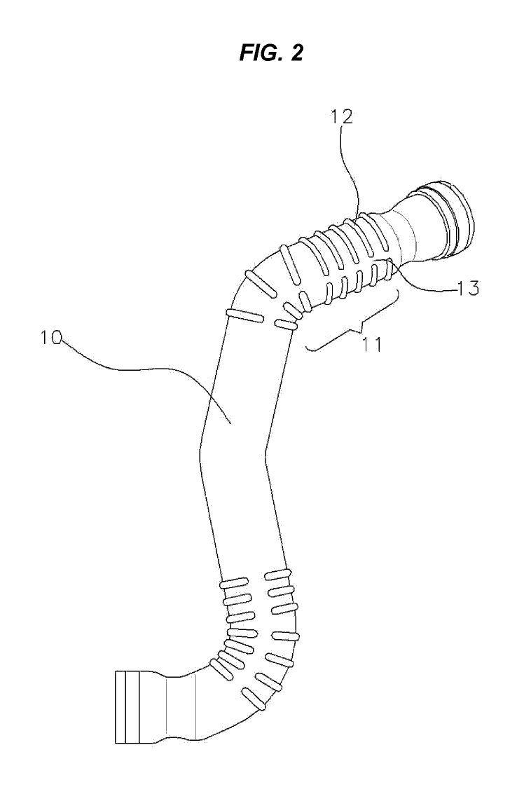

Referring to FIG. 2, an intercooler pipe 10 according to the present invention is made of synthetic resin having a predetermined elasticity wherein one end is connected to an intercooler and the other end is connected to a port 31 of a throttle body 30.

Furthermore, the intercooler pipe 10 is formed integrally and/or monolithically with one or more bellows 11 on which a plurality of wrinkles 12 are formed consecutively along a longitudinal direction thereof and which is made of the same material as the intercooler pipe wherein two bellows 11 are arranged to be disposed adjacently to the intercooler and the throttle body 30, respectively.

As shown in FIG. 2, each wrinkle 12 is formed in a ring shape or substantially in a ring shape to be protruded from a surface of the intercooler pipe 10 along a surrounding thereof wherein cutting portions 13 where the protrusion heights are formed differently (the protrusion height is lower than the remaining part or not formed partially) are provided. Since the cutting portions 13 are formed on the intercooler pipe, the flexibility of the intercooler pipe 10 is decreased relatively in the direction to which the cutting portions 13 are formed (rigidity is increased relatively) and thus bending thereof is limited.

That is, the force required for bending the intercooler pipe 10 toward a specific direction and the force required for bending the intercooler pipe 10 toward other directions are exhibited differently through the formation of the cutting portions 13.

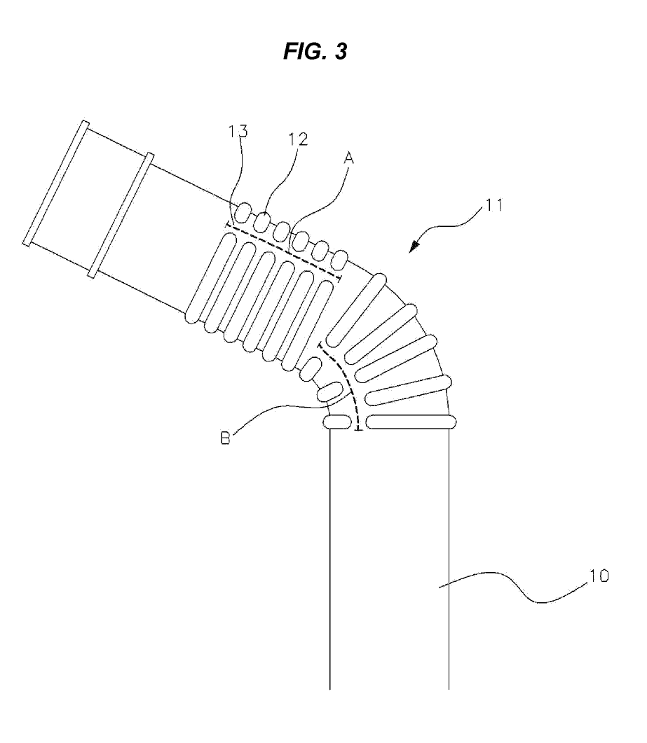

Furthermore, the cutting portions 13 are arranged to form a row in a straight line shape along a longitudinal direction of the intercooler pipe 10 in the some embodiments such as that illustrated in FIG. 2, or as shown in FIG. 3, the cutting portions may be offset to have a plurality of specific directions for inducing a slip of the intercooler pipe 10 or the bending thereof.

That is, the rows formed by the cutting portions 13 consist of a first row A and a second row B wherein the first row A and the second row B are arranged adjacently along a longitudinal directions on the bellows 11 but are spaced from each other along a surrounding of the bellows 11.

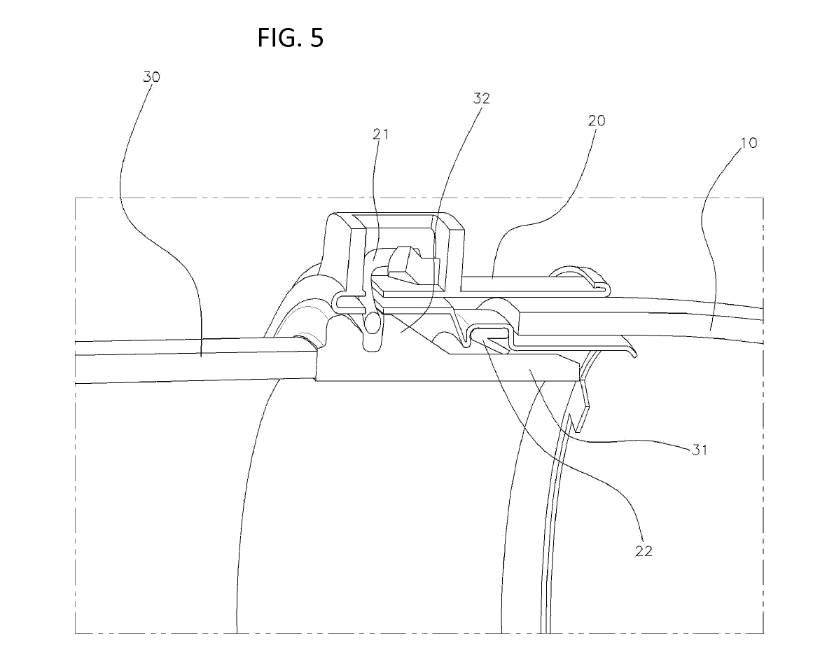

Meanwhile, the throttle body 30 according to the present invention is provided with a connection port 31 in a tube shape to be connected to the intercooler pipe 10 wherein, as shown in FIG. 5, a catching step 32 is formed along an outer peripheral surface of the connection port 31, which is protruded at a predetermined height from a surface of the connection port along a surrounding thereof and one side of which is formed with an oblique surface and the other side of which is formed with a flat vertical surface (that is, a sectional surface thereof is formed in a saw tooth shape).

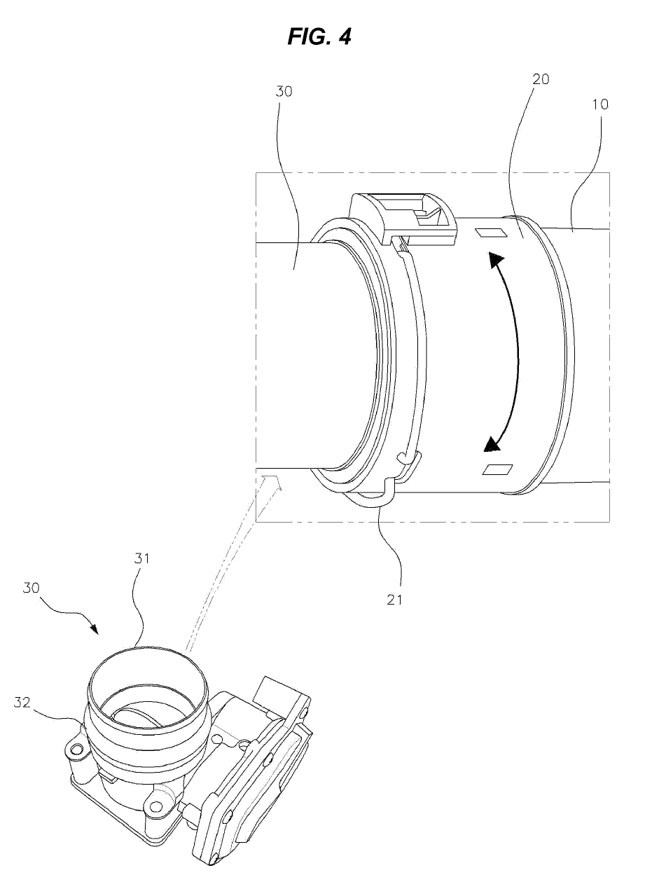

The intercooler pipe 10 connected to a connector 20, as shown in FIG. 4, is connected to the connection port 31. Referring to FIGS. 4 and 5, the connector 20 is provided with a stopper 21 a part of which may be protruded from an inner peripheral surface of the connector 20. That is, when the connection port 31 of the throttle body 30 is entered into the connector 20 fixed to an remote end at one side of the intercooler pipe 10, the stopper 21 is caught over the catching step 32 protruded from an outer peripheral surface of the connection port 31 (the stopper passes through an oblique surface and reaches to a vertical surface and then it is prevented from being retracted) thereby to be fastened.

Furthermore, even though the stopper 21 prevents the connector 20 from being separated from the connection port, the stopper is not tightened such an extent to inhibit the rotation of the connector 20 connected to the intercooler pipe 10 around the connection port 31 and thus a slip between the intercooler pipe 10 and the throttle body 30 is allowed.

In some cases, a connection port provided with a catching step having the same or similar configuration as in the throttle body 30 may be provided on the intercooler, and thus a slip between the intercooler and the intercooler pipe 10 may be allowed.

Further, a rubber seal 22 is arranged on the connector 20 for shielding between the connector 20 and the connection port 31 while the connector 20 is connected to the connection port 31. The rubber seal 22 may be arranged on a place (for example, a groove to which the stopper is fitted behind the catching step in FIG. 5). In various embodiments, the rubber seal is arranged on a front of the catching step 32 (right side in FIG. 5) wherein at least one or more of the friction force between the rubber seal 22 and the connector 20 and the friction force between the rubber seal 22 and the connection port 31 is set to be small to an extent to allow the rotation of the connector 20.

The friction force as described above may be set by manufacturing the rubber seal 22 with material having small friction coefficient or adjusting a gap between the rubber seal 22 and the connector 20 or between the rubber seal 22 and the connection port 31.

The intercooler pipe 10 according to the present invention, having the characteristics as described above, is manufactured with synthetic resin and thus can be further light-weighted, comparing to a conventional intercooler pipe made of a combination of rubber material and metal material and cost-saved, and further noise and vibration dampened more efficiently.

Further, the intercooler pipe 10 is provided with the bellows 11 where the cutting portions 13 are formed so as to improve flexibility such that the flexibility and rigidity of the intercooler pipe can be adjusted in accordance with specific directions. Accordingly, the flexibility of the intercooler pipe toward a specific direction to which the vibration is produced mainly is increased while the rigidity of the intercooler pipe 10 is further increased through the formation of the cutting portion 13, thereby inhibiting noise and vibration more efficiently.

Furthermore, the first row A and the second row B where the cutting portions 13 are to be provided are arranged in front/rear directions and up/down directions (or left/right directions) (on the basis of a vehicle body), respectively, so that the vibration frequency having other characteristics can be insulated further efficiently and the slip of the intercooler pipe 10 can be induced simply.

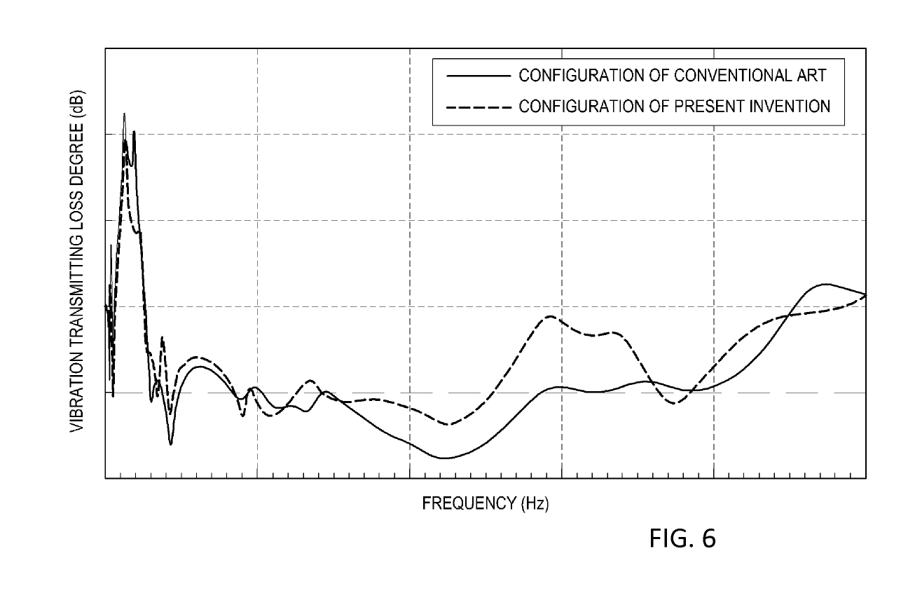

It is confirmed that the vibration transmitting loss degree (the vibration value obtained by deducting the vibration value produced at the intercooler as a vibration receiving point from the vibration value produced at the throttle body as a vibration adding point) is exhibited to be higher than that of the conventional intercooler pipe through FIG. 6. The higher vibration transmitting loss degree means an excellent vibration reducing characteristics and thus the vibration can be insulated more efficiently according to the present invention, comparing to the conventional configuration.

According to the present invention, the intercooler pipe is rotated (slipped) in accordance with the movement of an engine and the transmitting of the vibration produced from the engine and the noise that has been generated in accordance with the twisting of the conventional intercooler pipe can be inhibited.

Further, the cutting portion is formed at the bellows to adjust additionally the flexibility of the intercooler pipe to a specific direction so that the contact between the intercooler pipe and the surrounding components can be prevented wherein the cutting portions are arranged along the first row and the second row that are spaced from each other (in order to convert the vibration energy into kinetic energy or dampen more efficiently the vibration produced left/rightward or up/downward as well as front/rearward), allowing the intercooler pipe to be rotated.

According to the mounting structure of an intercooler pipe as configured above, the intercooler pipe is rotated (slipped) in accordance with the movement of the engine thereby to inhibit the transmitting of the vibration produced from the engine and the noise the noise that has been generated in accordance with the twisting of the conventional intercooler pipe.

Further, the cutting portions are formed on the intercooler pipe to adjust additionally the flexibility of the intercooler pipe toward a specific direction thereby to prevent the intercooler pipe from being in contact with the surrounding components wherein the cutting portions are arranged along the first row and the second row that are spaced from each other (in order to convert the vibration energy into kinetic energy or to dampen efficiently the vibration that is produced left/rightward or up/downward as well as front/rearward), allowing the intercooler pipe to be rotated.

For convenience in explanation and accurate definition in the appended claims, the terms “inner” or “outer”, “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting structure of an intercooler pipe, one end of which is connected to an intercooler and the other end of which is connected to a connection port of a throttle body, the mounting structure comprising:
the intercooler pipe including:
a bellow on which a plurality of wrinkles are formed consecutively protruding from a surface of the intercooler pipe along a longitudinal direction of the intercooler pipe; and
a cutting portion formed on the bellow and having a protrusion height that is different than a protrusion height of the wrinkles, wherein
each wrinkle in the plurality of wrinkles is formed substantially in a ring shape,
the cutting portion is arranged to form a row of a line shape along the longitudinal direction of the intercooler pipe such that a force required for bending the intercooler pipe toward a specific direction is different than a force required for bending the intercooler pipe toward other directions, and
the intercooler pipe is connected to the connection port of the throttle body to be rotated.

2. The mounting structure of an intercooler pipe of claim 1, wherein at least two or more of the rows are formed by the cutting portion, arranged adjacently on the bellow along the longitudinal direction of the intercooler pipe, and spaced apart from each other along a surrounding of the bellow.

3. The mounting structure of an intercooler pipe of claim 2, wherein two bellows are formed, one on the one end of the intercooler pipe connected to the intercooler and one on the other end of the intercooler pipe connected to the throttle body, respectively.

4. The mounting structure of an intercooler pipe of claim 3, wherein the intercooler pipe is made of a material comprising synthetic resin.

5. The mounting structure of an intercooler pipe of claim 1, further comprising:
a connector from an inner peripheral surface of which a stopper is protruded and which is connected to a remote end of the intercooler pipe to be fastened to the connection port of the throttle body, wherein when the connection port is entered into the connector, the stopper is caught over a catching step protruded from an outer peripheral surface of the connection port, and the connector allows the intercooler pipe to be rotated.

6. The mounting structure of an intercooler pipe of claim 5, further comprising:
a rubber seal arranged on the connector for shielding between the connector and the connection port while the connector is connected to the connection port, wherein at least one of the friction force between the rubber seal and the connector or the friction force between the rubber seal and the connection port is set to be small to allow rotation of the connector.

7. The mounting structure of an intercooler pipe of claim 2, further comprising:
a connector from an inner peripheral surface of which a stopper is protruded and which is connected to a remote end of the intercooler pipe to be fastened to the connection port of the throttle body, wherein when the connection port is entered into the connector, the stopper is caught over a catching step protruded from an outer peripheral surface of the connection port, and the connector allows the intercooler pipe to be rotated.

8. The mounting structure of an intercooler pipe of claim 3, further comprising:
a connector from an inner peripheral surface of which a stopper is protruded and which is connected to a remote end of the intercooler pipe to be fastened to the connection port of the throttle body, wherein when the connection port is entered into the connector, the stopper is caught over a catching step protruded from an outer peripheral surface of the connection port, and the connector allows the intercooler pipe to be rotated.

9. The mounting structure of an intercooler pipe of claim 4, further comprising:
a connector from an inner peripheral surface of which a stopper is protruded and which is connected to a remote end of the intercooler pipe to be fastened to the connection port of the throttle body, wherein when the connection port is entered into the connector, the stopper is caught over a catching step protruded from an outer peripheral surface of the connection port, and the connector allows the intercooler pipe to be rotated.
